(19) United States
(12) Patent Application Publication
(10) Pub. No.: US 2011/0089256 A1
(43) Pub. Date: Apr. 21, 2011

(54) FLUID EJECTION APPARATUS

(75) Inventors: Hideki KOJIMA, Matsumoto-shi (JP); Shigeo SUGIMURA, Okaya-shi (JP); Takahiro MATSUZAKI, Shiojiri-shi (JP)

(73) Assignee: SEIKO EPSON CORPORATION, Tokyo (JP)

(21) Appl. No.: 12/902,347

(22) Filed: Oct. 12, 2010

(30) Foreign Application Priority Data
Oct. 21, 2009 (JP) 2009-242160

(51) Int. Cl. B05B 1/08

(52) U.S. Cl. 239/102.2

(57) ABSTRACT

A fluid ejection apparatus ejecting fluid from an ejection port, includes: a suction port provided at a position apart from the ejection port and applied with a negative pressure; and a fluid channel provided between the vicinity of the ejection port and the suction port, and configured to suck the fluid in the vicinity of the ejection port by the surface tension of the fluid and move the same toward the suction port.

### BACKGROUND

1. Technical Field

The present invention relates to a technology configured to eject fluid from an ejection port.

2. Related Art

In recent years, a surgical method for incising an operation site or excising foreign substances such as thrombus or tumor by means of a pressure of the fluid by pressurizing fluid such as water or physiological saline and ejecting the same to the operation site during the surgical operation is developed. In a fluid ejection apparatus used in the surgical operation as described above is configured to eject the fluid from an ejection port provided at an extremity of a nozzle. At the time of the surgical operation, a surgeon holds the nozzle, directs the ejection port to the operation site, and causes fluid to be ejected from the ejection port, whereby incision of the operation site or excision of the tumor or the like is achieved.

At the time of the surgical operation, it is important to eject the fluid exactly to the operation site. Therefore, the surgeon causes the fluid to eject normally in a state in which the ejection port is set to a position close to the operation site. As a matter of fact, if the ejected fluid or blood flowing out at the time of incision is accumulated in the periphery of the operation site, the surgeon can hardly view the operation site, and hence it becomes difficult to bring the ejection port close to an accurate position of the operation site. Accordingly, there is proposed a technology in which a suction port connected to a suction pump is provided in the vicinity of the ejection port for sucking and removing blood or the like in the periphery of the ejection port from the suction port when the ejection port is brought close to the operation site, thereby enabling securement of the visibility in the periphery of the ejection port and ejection of the fluid to the accurate position (see JP-A-6-90957).

JP-A-6-90957 is an example of related art.

However, with the proposed technology, a negative pressure at the suction port is exerted also to the operation site. In other words, since the suction port is provided in the vicinity of the ejection port, if the ejection port is brought to the position close to the operation site, the suction port is also brought close to the operation site. Therefore, the negative pressure at the suction port is exerted to the operation site. Consequently, there arise problems such that the operation site is displaced due to the negative pressure, or the operation site may be sucked into the suction port and hence become damaged. If the suction port is provided at a position far from the ejection port so as to prevent the negative pressure from being exerted to the operation site, the fluid in the periphery of the ejection port or blood can hardly be sucked, and hence the visibility in the periphery of the ejection port can hardly be secured.

### SUMMARY

An advantage of some aspects of the invention is to provide a technology which is capable of preventing a negative pressure at a suction port from being exerted on an operation site, while securing the visibility in the periphery of an ejection port by sucking fluid, blood or the like flowed out from the operation site.

An aspect of the invention provides a fluid ejection apparatus ejecting fluid from an ejection port, including:

a suction port provided at a position apart from the ejection port and applied with a negative pressure; and

a fluid channel provided between the vicinity of the ejection port and the suction port, and configured to suck the fluid in the vicinity of the ejection port by the surface tension of the fluid and move the same toward the suction port.

With the fluid ejection apparatus of the aspect of the invention, the suction port is provided at the position apart from the ejection port, and the fluid channel is provided between the suction port and the position in the vicinity of the ejection port. The fluid channel is configured to cause the fluid in the vicinity of the ejection port to be sucked on the basis of the surface tension of the fluid, and move the sucked fluid toward the suction port.

By utilizing the surface tension of the fluid and moving the fluid in the vicinity of the ejection port, the fluid can be moved to the suction port even without the application of the negative pressure to the position in the vicinity of the ejection port. In this configuration, even though the suction port is provided at the position apart from the ejection port, the fluid in the vicinity of the ejection port can be removed by the suction port. Therefore, the fluid in the vicinity of the ejection port can be removed even though the suction port is formed apart from the ejection port to avoid the action of the negative pressure at the suction port from acting on an operation site, so that the visibility in the periphery of the ejection port can be secured.

The fluid can be moved on the basis of the surface tension of the fluid because of the following reason. That is, since the fluid has a property of spreading along the surface of a substance (so called, wettability), the fluid spreads along an inner wall which is in contact with the inner wall of the fluid channel, so that the surface area of the fluid is increased. On the other hand, the fluid also has a property of restricting the surface area from increasing by the surface tension, an attempt is made to reduce the surface area by covering the surface of the spread fluid with the fluid by itself, whereby a force to move the entire fluid in the direction of spread is generated. In this manner, since the force to move is generated in the fluid due to the surface tension, the fluid in the fluid channel can be moved using this force. Therefore, the fluid channel may be of any type as long as the fluid in the channel can be moved by this force. For example, in order to move the fluid upward (or obliquely upward) against the gravitational force, a thinner fluid channel may be employed. When moving the fluid against the gravitational force, the fluid can be moved until the force to move the fluid and the gravitational force acting on the fluid in the channel (the weight of the fluid in the channel) are counterbalanced. Therefore, with the employment of the thinner channel, the weight of the fluid in the channel can be reduced, and hence the fluid in the channel can be moved over a long distance. Accordingly, the suction port can be provided at a position farther from the ejection port, and hence the probability of various problems caused by the application of the negative pressure to the operation site can be avoided reliably.

The ejection port may be provided at an extremity of a tubular member, and the suction port is provided along an outer surface of the tubular member at the position apart from the ejection port in an axial direction of the tubular member. It is also preferable that a groove is provided on the outer surface of the tubular member between a position in the vicinity of the extremity of the tubular member to a position where the suction port is provided, and the groove is used as the fluid channel.

In this configuration, the fluid channel can be provided only by forming the groove on the outer surface of the tubular member, so that the apparatus configuration of the fluid ejection apparatus can be maintained to be simple and, in addition, the step of manufacturing the fluid ejection apparatus can be simplified. In addition, even when substances such as fragment of the excised living tissue are attached, it can be removed easily. Therefore, the fluid removing capability can be maintained.

The ejection port may be provided at an extremity of a tubular member, the suction port is provided along an outer surface of the tubular member at the position apart from the ejection port in an axial direction of the tubular member and, in addition, fluid channel are configured by a plurality of fibrous members extending from the position in the vicinity of the extremity of the tubular member toward the suction port.

Since the fibrous members form channels among fibers, they are capable of taking the fluid therein by the surface tension and moving the same toward the suction port. In this configuration, the fluid channels can be formed only by providing the fibrous member, the apparatus configuration of the fluid ejection apparatus can be maintained to be simple, and the step of manufacturing the fluid ejection apparatus can be simplified. Since, a number of the fluid channels can be formed by a number of the fibrous members, the fluid in the vicinity of the ejection port can be moved efficiently toward the suction port.

The fibrous members may be of any type as long as they can move the fluid from the position in the vicinity of the ejection port to the suction port. For example, the fluid channels may be formed by an assembly of a plurality of long fibers extending from the position in the vicinity of the ejection port to the suction port, or may be formed by paving relatively short fibers from the position in the vicinity of the ejection port to the suction port. The orientation of the fibers is not limited to the direction connecting the position in the vicinity of the ejection port to the suction port. For example, the fibers may be provided so as to extend upright and outward from the outer surface of the tubular member. In this case as well, the channels are formed among the fibers, and hence the fluid can be moved by the surface tension of the fluid.

The extremity of the fibrous members on the side of the ejection port may be provided so as to project with respect to the position of the extremity of the tubular member.

In this configuration, when the ejection port is brought close to the operation site, the fibrous members can be pressed against the operation site, and brought into tight contact with each other. Therefore, the fluid accumulated in the operation site can be sucked reliably through the fluid channel formed by the fibrous members. Also, by surrounding the ejection port with the fibrous member, a splash of fluid occurring when the fluid hits on the operation site or splash of blood flowing out from the operation site are prevented from flying into the periphery.

The fluid ejection apparatus according to the aspect of the invention may employ the following configuration for ejecting the fluid. That is, the fluid ejection apparatus ejecting fluid from an ejection port may be configured to include:

a fluid chamber configured to receive supply of the fluid and connected to the ejection port via a connecting flow channel; and

a pulsed flow ejecting unit configured to eject the fluid in the fluid chamber from the ejection port in a pulsed manner by changing the capacity of the fluid chamber.

The expression “eject the fluid in a pulsed manner” means that the fluid is ejected in association with variations in flow rate or flow velocity of the ejected fluid. This mode of ejecting the fluid in a pulsed manner includes an intermittent ejection in which the fluid is ejected while repeating ejection and stop. However, what is essential is just that the flow rate and the flow velocity of the fluid are varied, and hence it does not necessarily have to be the intermittent ejection. When the fluid is ejected in a pulsed manner as described above, the fluid is ejected while varying the flow rate or the flow velocity of the fluid. Therefore, the total amount of the fluid to be ejected can be restricted to a small amount in comparison with the case where the fluid is ejected at a constant flow rate (or at a constant flow speed). In this configuration, the fluid to be accumulated in the vicinity of the ejection port can be restricted to a smaller amount. Therefore, the visibility of the operation site can be secured sufficiently by moving the fluid to the suction port and removing the same.

### BRIEF DESCRIPTION OF THE DRAWINGS

The invention will be described with reference to the accompanying drawings, wherein like numbers reference like elements.

FIG. 1 is an explanatory drawing showing a configuration of a fluid ejection apparatus according to an embodiment.

FIGS. 2A and 2B are explanatory drawings showing a detailed configuration of an ejection mechanism provided in the fluid ejection apparatus according to the embodiment.

FIG. 3 is an explanatory drawing illustrating a state in which an operation site of a living organism is being excised using the fluid ejection apparatus in the embodiment.

FIGS. 4A and 4B are explanatory drawings showing a detailed structure of a nozzle portion and a flow channel tube of the fluid ejection apparatus according to the embodiment.

FIG. 5 is an explanatory drawing showing a state in which fluid or blood accumulated in the periphery of the operation site is being removed using the fluid ejection apparatus according to the embodiment.

FIG. 6 is an explanatory drawing of the nozzle portion according to a modification in which a groove portion is provided also on an end surface thereof viewed from the direction of the end surface of the nozzle portion.

FIGS. 7A and 7B are explanatory drawings showing a nozzle portion according to a modification in which fluid is moved using a flow channel between brushes provided in the periphery of the nozzle portion.

FIG. 8 is an explanatory drawing showing a state in which fluid accumulated in the operation site is removed using the nozzle portion according to the modification.

### DESCRIPTION OF EXEMPLARY EMBODIMENTS

In the following description, in order to clarify contents of the invention according to the present application described above, an embodiment will be described in the following order.

A. Configuration of Fluid Ejection Apparatus

B. Nozzle Portion in the Embodiment

C. Modifications
C-1. First Modification
C-2. Second Modification

### A. Configuration of Fluid Ejection Apparatus

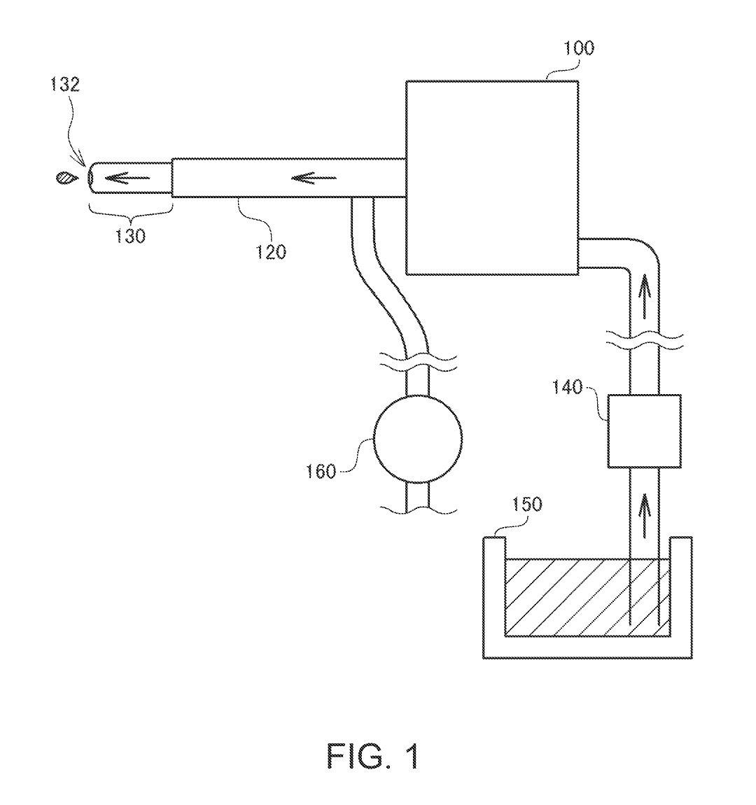

FIG. 1 is an explanatory drawing showing a configuration of a fluid ejection apparatus according to an embodiment of the invention. As illustrated, a fluid ejection apparatus 10 according to the embodiment includes a fluid tank 150 in which fluid such as physiological saline or drug solution is stored, a suction pump 140 configured to suck the fluid from the fluid tank 150, and an ejection mechanism 100 configured to pressurize and feed the fluid sucked by the suction pump 140 to a flow channel tube 120. The fluid pressurized by the ejection mechanism 100 passes through the flow channel tube 120, reaches a nozzle portion 130 provided at an extremity of the flow channel tube 120, and is ejected from an ejection port 132 provided at an extremity of the nozzle portion 130. An operation site of a living organism can be excised by using a pressure of the fluid ejected by the fluid ejection apparatus 10. When excising the operation site at the time of surgical operation, it is desirable to enhance the excision capability by ejecting the fluid at a high pressure. Therefore, the fluid ejection apparatus 10 in the embodiment includes the ejection mechanism 100 having a configuration as shown below.

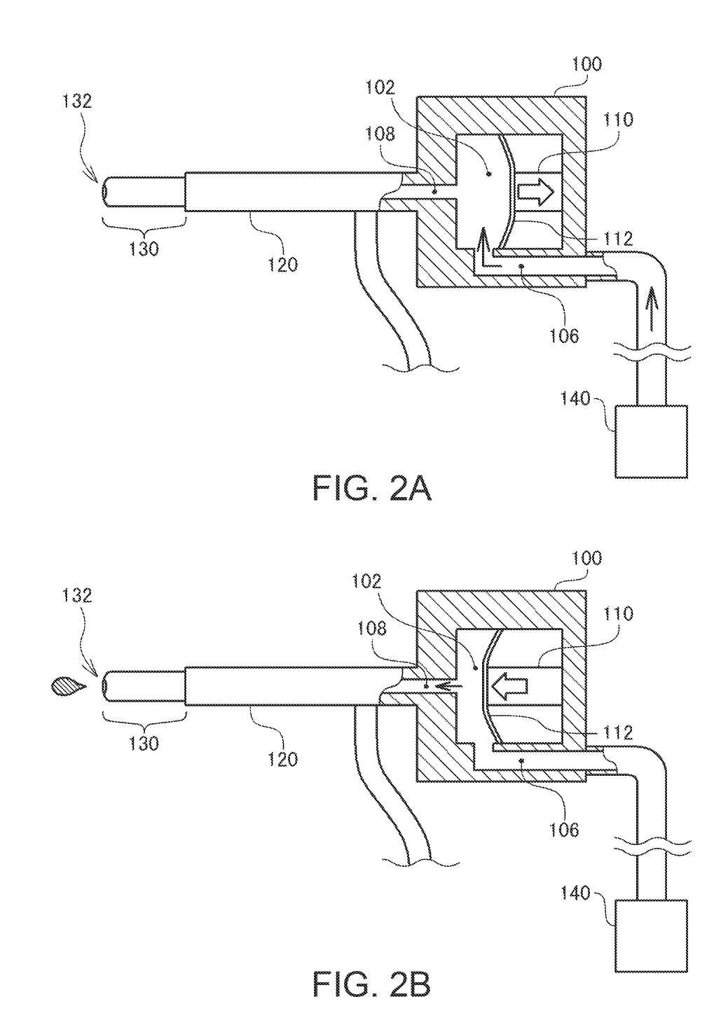

FIGS. 2A and 2B are explanatory drawings showing a detailed configuration of the ejection mechanism provided in the fluid ejection apparatus according to the embodiment. As shown in FIG. 2A, the ejection mechanism 100 includes a supply flow channel 106 to which fluid is supplied by the suction pump 140, a pressure chamber 102 in which the fluid supplied from the suction pump 140 is filled, and an ejection flow channel 108 from which the fluid from the pressure chamber 102 is pushed toward the flow channel tube 120. The pressure chamber 102 includes a piezoelectric element 110 connected thereto via a film member (so called, a diaphragm) 112. A voltage is applied to the piezoelectric element 110, whereby the piezoelectric element is expanded and contracted. Consequently, the film member 112 is driven, so that the capacity in the pressure chamber 102 can be varied.

When ejecting the fluid, as shown with a hollow arrow in FIG. 2A, the voltage is applied to the piezoelectric element 110 to contract the piezoelectric element 110 and enlarge the capacity of the pressure chamber 102. At this time, as shown by black arrows in the drawing, the fluid is supplied to the pressure chamber 102 by the suction pump 140. Therefore, the interior of the pressure chamber 102 can be filled with fluid in a state in which the capacity of the pressure chamber 102 is increased. Subsequently, as shown in the hollow arrow in FIG. 2B, the piezoelectric element 110 is expanded to compress the pressure chamber 102.

Two flow channels, namely, the ejection flow channel 108 and the supply flow channel 106, are connected to the pressure chamber 102. Since these flow channels are formed to be narrow, the pressure of the fluid in the pressure chamber 102 can be enhanced sufficiently by compressing the pressure chamber 102 with the piezoelectric element 110. With this pressure, the fluid in the pressure chamber 102 is strongly pushed out toward the ejection flow channel 108 and, consequently, the fluid from a tip of the nozzle portion 130 connected to the ejection flow channel 108 can be ejected at a high speed. Although the fluid in the pressure chamber 102 is pushed out to the supply flow channel 106 as well as the ejection flow channel 108, since the ease of flow of the fluid into the flow channel is determined by the length of the flow channel or the cross-sectional area of the flow channel or the like, the amount of fluid flowing into the supply flow channel 106 can be restricted to be smaller than the amount of fluid flowing into the ejection flow channel 108 by setting the lengths and the cross-sectional areas of the supply flow channel 106 and the ejection flow channel 108 adequately. Accordingly, most part of the fluid pressurized in the pressure chamber 102 can be pushed out to the ejection flow channel 108, and ejected from the ejection port 132 connected to the ejection flow channel 108 at a high speed.

After having ejected the fluid drops, the fluid drops can be ejected again by causing the piezoelectric element 110 to be contracted again (see FIG. 2A) and then expanded (see FIG. 2B). In the fluid ejection apparatus 10 in the embodiment, the repetitive ejection of the fluid drops at a high speed is enabled by repeating actions as described above. Therefore, quick excision of the operation site of the living organism is enabled by the utilization of the high pressure of the high-speed fluid drops.

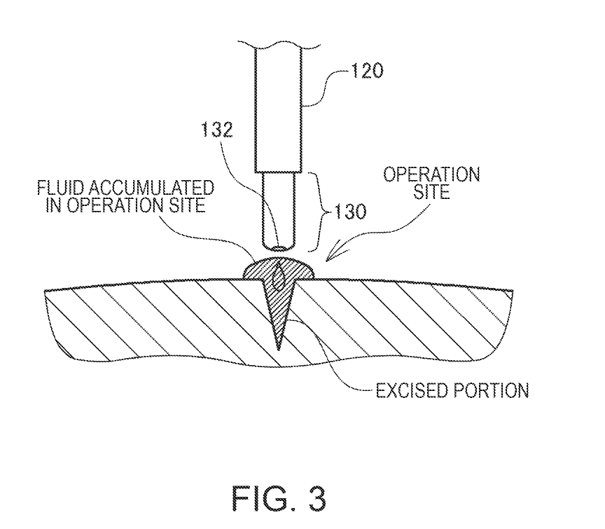

FIG. 3 is an explanatory drawing illustrating a state in which the operation site of the living organism is being excised using the fluid ejection apparatus in the embodiment. As illustrated, when excising the operation site, the fluid is ejected with the ejection port 132 at the extremity of the nozzle portion 130 positioned close to the operation site. Accordingly, fluid can be ejected to the accurate position in the operation site, whereby excision is achieved at the accurate position in the operation site. In addition, when the operation site is excised by ejecting fluid, the ejected fluid or blood flowed out from the removed portion is accumulated in the operation site. Consequently, visibility of the operation site may be lowered, and hence the ejection of the fluid to the accurate position of the operation site may become difficult. Therefore, the fluid ejection apparatus 10 in the embodiment includes a suction pump 160 connected to the nozzle portion 130 (see FIG. 1), so that fluid or blood accumulated in the operation site can be removed by sucking the same from the suction port of the nozzle portion 130.

If the suction port is provided at a position close to the operation site such as the extremity of the nozzle portion 130, a negative pressure is exerted on the operation site as described above. Consequently, a problem such that the suction port sucks the operation site and hence causes the operation site to become damaged or the operation site moves may occur. Therefore, the suction port is preferably provided at a position apart from the operation site to some extent. However, if the suction port is provided at the position apart from the operation site, the fluid or the blood accumulated in the operation site cannot be sucked easily any longer. Therefore, in the fluid ejection apparatus 10 in the embodiment, with the nozzle portion 130 configured as described below, the suction port is provided at a position apart from the operation site and hence such event that the suction port sucks the operation site can be prevented and, simultaneously, the fluid accumulated in the operation site can be removed efficiently.

### B. Nozzle Portion in the Embodiment

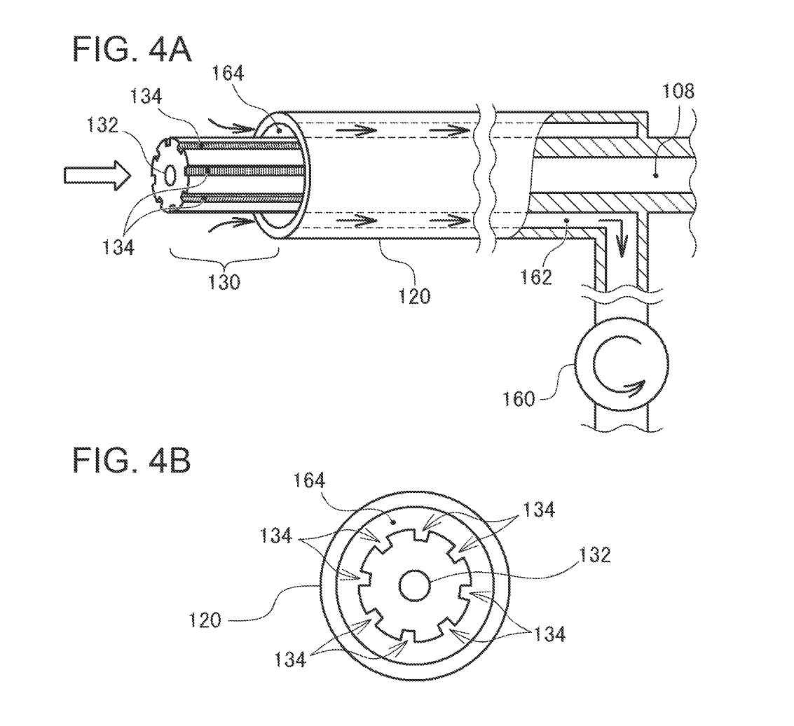

FIGS. 4A and 4B are explanatory drawings showing a detailed structure of the nozzle portion and the flow channel tube of the fluid ejection apparatus according to the embodiment. As shown in FIG. 4A, the nozzle portion 130 in the embodiment is provided with a plurality of groove portions 134 from an end surface where the ejection port 132 is provided toward the flow channel tube 120. The grooves of the groove portion 134 are thin, and are configured to be able to attract the fluid into the groove portions 134 by so called a capillary phenomenon if the fluid is attached thereto. The flow channel tube 120 to which the nozzle portion 130 is connected includes two flow channels, namely, the ejection flow channel 108 connected to the ejection mechanism 100 and to the ejection port 132 and a suction flow channel 162 connected to the suction pump 160 and a suction port 164 as illustrated. The suction flow channel 162, specifically, is provided so as to surround the outside of the ejection flow channel 108. Therefore, at an end of the flow channel tube 120 (the left side end in the drawing), the suction port 164 is opening in a state of surrounding the nozzle portion 130 connected to the ejection flow channel 108. In other words, in the fluid ejection apparatus 10 in the embodiment, the suction port 164 is provided at a position apart from the ejection port 132, which is the opposite direction from the direction in which the ejection port 132 ejects the fluid.

FIG. 4B shows a state in which the nozzle portion 130 is viewed from the direction indicated by a hollow arrow in FIG. 4A. As illustrated, the groove portions 134 are provided so as to surround the periphery of the ejection port 132 and, from this direction, the groove portions 134 are in the state of being surrounded by the suction port 164. As described above, since the groove portions 134 are extended to a position of the suction port 164 (see FIG. 4A), the negative pressure can be applied to the portion close to the suction port 164 of the respective groove portions 134 by driving the suction pump 160. With such the configuration, the fluid ejection apparatus 10 in the embodiment removes the fluid or blood accumulated in the periphery of the operation site as follows.

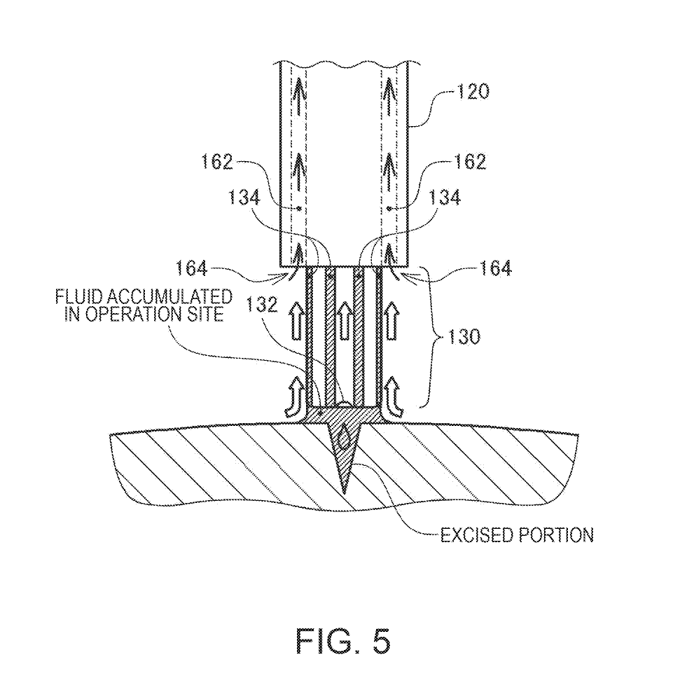

FIG. 5 is an explanatory drawing showing a state in which fluid or blood accumulated in the periphery of the operation site is being removed using the fluid ejection apparatus according to the embodiment. As illustrated, when the fluid is ejected in a state in which the ejection port 132 is brought close to the operation site, the fluid accumulates in the operation site, and the accumulated fluid comes into contact with the extremity of the nozzle portion 130. In this case, since the groove portions 134 are provided in the periphery of the ejection port 132 at the extremity of the nozzle portion 130, the fluid accumulated in the operation site enters the groove portions 134. Then, since the groove portions 134 are formed into thin flow channels, the fluid in the groove portions 134 is moved toward the suction port 164 along the interior of the groove portions 134 by so called the capillary phenomenon as indicated by hollow arrows in the drawing. By moving the fluid to the position in the vicinity of the suction port 164 using the capillary phenomenon, the incoming fluid can be sucked out and removed from the groove portions 134 by generating the negative pressure in the vicinity of the suction port 164 by the suction pump 160. The groove portions 134 preferably extend to the interior of the suction port 164 so as to guide the fluid reliably by the suction port 164.

The capillary phenomenon generally refers to a phenomena of fluid which moves in the direction against the gravitational force by a property of fluid which comes into tight contact with a wall surface of the flow channel (so called, wettability) and the surface tension of the fluid in many cases. However, in this specification, the capillary phenomena is not limited to the phenomena of fluid which moves in the direction against the gravitational force, but includes general phenomena associated with the movement of fluid caused by the wettability and the surface tension.

In this manner, in the fluid ejection apparatus 10 in the embodiment, the fluid accumulated in the operation site is moved by utilizing the capillary phenomenon by providing the thin groove portions 134 at the nozzle portion 130 which comes into contact with the operation site. In this configuration, since the fluid can be moved spontaneously to the suction port 164 through the capillary phenomenon, the fluid of the operation site can be removed even when the suction port 164 is provided at a position apart from the operation site. Since the suction port 164 is opened at upper end portions of the groove portions 134, the negative pressure is applied only to part of the upper ends of the groove portions 134, but not to a position in the vicinity of lower ends of the groove portions 134 which are close to the operation site. Therefore, the probability that the operation site is sucked by the negative pressure can be avoided for sure.

In addition, the fluid in the groove portions 134 can be removed quickly by the application of the negative pressure only to part of the upper ends of the groove portions 134 even though it is not applied to the entire parts of the groove portions 134, and hence the fluid accumulated in the operation site can be removed quickly from the following reasons. In other words, when the negative pressure is applied to part of the upper ends of the groove portions 134 by the suction port 164 and the fluid of the corresponding part is removed, the fluid located in the groove portions 134 moves quickly toward the suction port 164 by the capillary phenomenon by an amount corresponding to the removed fluid. Accordingly, since the fluid in the groove portions 134 enters again the range where the negative pressure from the suction port 164 affects, the suction port 164 can suck and remove the fluid again. Then, if the part of the fluid is removed by the suction port 164, the fluid located in the groove portions 134 moves toward the suction port 164 again thereby, and hence the fluid flows toward the suction port 164 continuously.

In this manner, by the removal of the part of the fluid in the groove portions 134, the fluid located in the groove portions 134 can be caused to flow toward the suction port 164 taking this opportunity. Accordingly, nevertheless the negative pressure is applied only to the part of the groove portions 134, the entire fluid located in the groove portions 134 can be removed by the suction port 164. Then, the flow of the fluid generated in the interiors of the groove portions 134 can be maintained by removing the incoming fluid in sequence by the suction port 164, the fluid in the operating site can be moved continuously toward the suction port 164. Accordingly, the fluid in the operation site can be removed quickly.

Since the fluid has a property to be bound together on the basis of the surface tension, not only a force to move toward the suction port 164 by the above-described capillary phenomenon, but also a force to move toward the suction port 164 in association with the fluid sucked by the suction port 164 act thereon. In other words, when the negative pressure is applied to part of the fluid located in the groove portions 134 to suck that part, the fluid in the respective groove portions 134 tends to be bound together. Therefore, a force to attract the fluid toward the suction port 164 is applied to the entire fluid located in the groove portions 134 by being pulled by the sucked portion. Then, when the entire fluid in the groove portions 134 is pulled toward the suction port 164, the fluid accumulated in the operation site is in turn pulled by the fluid located in the groove portions 134 and sucked into the groove portions 134.

In this manner, by applying the negative pressure to the part of the upper ends of the groove portions 134, the negative pressure can be applied to the entire fluid located in the groove portions 134 by the fluid's property of binding together. In addition, the negative pressure can be applied to the fluid accumulated in the operation site indirectly via the fluid in the groove portions 134. By applying the negative pressure indirectly to the fluid in the operation side via the groove portions 134 in addition to moving the fluid in the operation site on the basis of the capillary phenomenon, the fluid accumulated in the operation site can be moved quickly and removed by means of the suction port 164.

The property of moving on the basis of the capillary phenomenon and the property of binding together on the basis of the surface tension are properties possessed only by the fluid as a matter of course. Therefore, such event that the operation site itself is attracted by the suction port 164 cannot occur. By utilizing the properties possessed only by the fluid, the fluid ejection apparatus 10 in the embodiment can remove the fluid accumulated in the operation site quickly while reliably avoiding the probability of sucking the operation site.

In addition, the fluid ejection apparatus 10 in the embodiment is provided with the groove portions 134 so as to surround the ejection port 132 (see FIGS. 4A and 4B), the fluid accumulated in the operation site can be taken into the groove portions 134 efficiently. In other words, the fluid accumulated in the operation site is fluid ejected from the ejection port 132 or blood or body fluid flowed out from the excised portion, and hence it is accumulated around the ejection port 132 while spreading to the periphery thereof. Therefore by surrounding the periphery of the ejection port 132 with the groove portions 134, the fluid can be taken into the groove portions 134 when it spreads to the periphery thereof. Accordingly, the fluid accumulated in the operation site can reliably be taken into the groove portions 134. Consequently, the fluid or the blood in the operation site can be moved to the suction port 164 and removed quickly further reliably.

As described thus far, in the fluid ejection apparatus 10 in the embodiment, with the provision of the groove portions 134 from the portion in the vicinity of the ejection port 132 to the suction port 164, the fluid accumulated in the operation site is moved to the suction port 164 by utilizing the capillary phenomenon. Therefore, even though the suction port 164 is apart from the operation site, the fluid accumulated in the operation site can be removed by the suction port 164. By utilizing the fluid's property of binding together on the basis of the surface tension, the fluid is moved toward the suction port 164 by applying the negative pressure indirectly to the fluid in the operation site. The property of moving on the basis of the capillary phenomenon and the property of binding together on the basis of the surface tension are properties possessed only by the fluid as a matter of course. Therefore, such event that the operation site itself is sucked cannot occur by utilizing the specific properties of the fluid. Then, the fluid accumulated in the operation side can be removed continuously by sucking the fluid moved to the suction port 164 by the suction port 164. Accordingly, the fluid in the operation site is removed quickly and hence the visibility of the operation site is reliably secured while avoiding the probability of sucking the operation site and hence causing the operation site to be damaged.

In the fluid ejection apparatus 10 in the embodiment, fluid ejection at a high speed is achieved by compressing the pressure chamber 102 as described above (see FIGS. 2A and 2B). Therefore, a sufficient excision capability is obtained without continuously ejecting the fluid, and hence the total amount of the fluid can be restricted to a small amount by ejecting the fluid in a pulsed manner instead of ejecting continuously. In this configuration, the fluid to be accumulated in the operation site can be restricted to a small amount. Therefore, the visibility of the operation site can be secured sufficiently by moving the fluid in the operation site to the suction port 164 by the groove portions 134 and removing the same. In the example, the expression, “eject the fluid in a pulsed manner” means a state in which the fluid is ejected in association with regular or irregular variations in flow rate or flow velocity of the fluid, while the direction of flow of the fluid is constant. When the fluid is ejected in a pulsed manner as described above, the fluid is ejected while varying the flow rate or the flow velocity of the fluid. Therefore, the total amount of the fluid to be ejected can be restricted to a small amount in comparison with the case where the fluid is ejected at a constant flow rate or at a constant flow velocity. Therefore, the visibility of the operation site can be secured sufficiently only by moving the fluid accumulated in the operation site to the suction port 164 by the groove portions 134 and removing the same.

### C. Modifications

Modifications of the embodiment described above will be described below. In the modifications shown below, like numbers reference elements similar to those in the embodiment described above, and detailed description of the same parts is omitted.

### C-1. First Modification

In the embodiment described above, the groove portions 134 are described to be provided on a side surface of the nozzle portion 130 (see FIGS. 4A and 4B). However, the groove portions may be provided on the end surface of the nozzle portion 130 in addition to the side surface thereof.

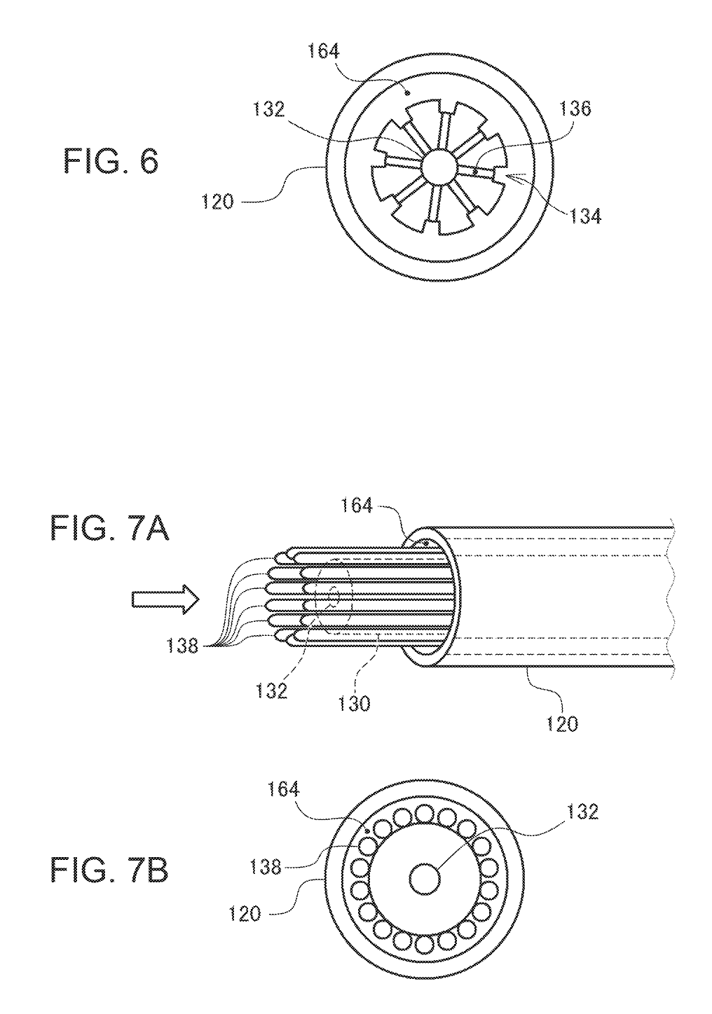

FIG. 6 is an explanatory drawing of the nozzle portion in a modification in which a groove portion is provided also on an end surface thereof viewed from the direction of the end surface of the nozzle portion. As illustrated, the nozzle portion 130 in the modification is provided with thin end surface grooves 136 on the end surface where the ejection port 132 is provided, and the end surface grooves 136 are connected to the groove portions 134 provided on the side surface of the nozzle portion 130. When the ejection port 132 is brought toward the operation site, the end surface of the nozzle portion 130 is located at a position closest to the operation site (see FIG. 5). Therefore, with the provision of the end surface grooves 136 on the end surface as described above, the fluid accumulated in the operation site can be taken into the groove portions 134 reliably via the end surface grooves 136. Since the end surface grooves 136 are opened widely with respect to the fluid accumulated in the operation site, the accumulated fluid can be taken efficiently therein. In addition, the fluid accumulated in the operation site is accumulated while spreading around the ejection port 132 to the periphery. Therefore, by extending the end surface grooves 136 to a position close to the ejection port 132, if the fluid is accumulated in the operation site even by a small amount, the accumulated fluid can be taken into the end surface grooves 136 and removed therefrom immediately. Therefore, the fluid can be removed even by the small amount and, consequently, the visibility in the operation site can be secured further reliably.

### C-2. Second Modification

The fluid ejection apparatus in the embodiment described above has been described such that the groove portions 134 are provided in the periphery of the nozzle portion 130, and the fluid is moved to the suction port 164 by the groove portions 134. However, it is also possible to provide a number of brushes in the periphery of the nozzle portion 130 to move the fluid toward the suction port 164 through flow channels formed between the brushes.

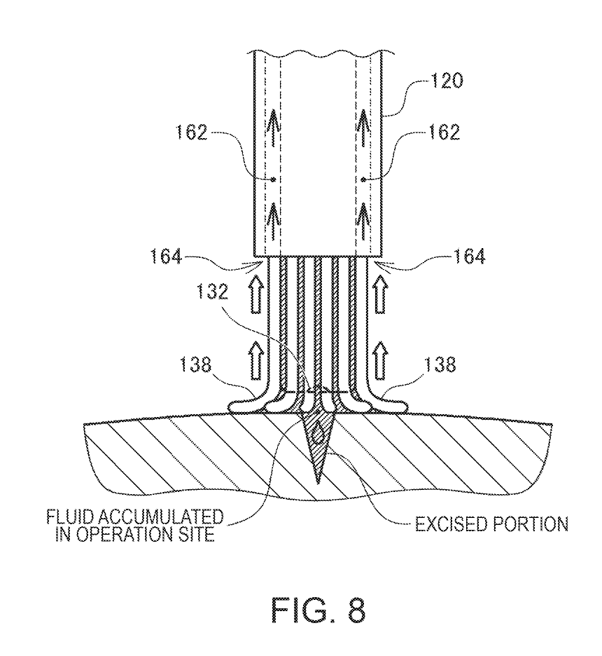

FIGS. 7A and 7B are explanatory drawings showing a nozzle portion according to a modification in which fluid is moved using a flow channel between brushes provided in the periphery of the nozzle portion. As illustrated in FIG. 7A, the nozzle portion 130 in the modification is provided with a number of the brushes 138 in the periphery of the nozzle portion 130. When viewing in the direction indicated by a hollow arrow in FIG. 7A, the brushes 138 surround the ejection port 132 (see FIG. 7B). As indicated in FIG. 7A, the brushes 138 are provided in a state in which extremity portions thereof project forward of the position of the ejection port 132 (the leftward in FIG. 7A). In addition, the other end of the each brush 138 is connected to the suction port 164 provided on an end surface of the flow channel tube 120, and the negative pressure of the suction port 164 can be applied to the end portion of the each brush 138. In the nozzle portion of the modification, the suction port 164 is provided at a position apart from the ejection port 132, which is the opposite direction from the direction in which the ejection port 132 ejects the fluid.

FIG. 8 is an explanatory drawing showing a state in which fluid accumulated in the operation site is removed using the nozzle portion according to the modification. When the brushes 138 are provided at the nozzle portion 130, the spaces defined among the brushes 138 form fine flow channels. Therefore, as indicated by a hollow arrow in the drawing, the fluid accumulated in the operation site can be moved toward the suction port 164 on the basis of the capillary phenomenon. By forming the brushes 138 of soft members, the extremity portions of the brushes 138 can be spread around the operation site by pressing the extremities of the brushes 138 against the operation site as illustrated. In this configuration, the fluid can be taken from side surfaces of the brushes 138 to the spaces among the brushes 138. Therefore, the fluid can be taken efficiently by increasing the surface area of the portion for taking the fluid therein.

In addition, the brushes 138 being pressed against the operation site and hence bent thereby are apt to restore its original shape by the resiliency. Therefore, the brushes 138 can be brought into a tight contact with the operation site reliably by this force. Therefore, the fluid in the operation site can be taken reliably into the spaces among the brushes 138 without letting them out. In addition, by surrounding the periphery of the ejection port 132 with the brushes 138 and bringing the brushes 138 into tight contact with the operation site, a splash of fluid occurring when the fluid hits on the operation site or a splash of blood flowing out from the operation site is prevented from flying into the periphery. Therefore, the visibility in the periphery of the operation site can be secured further reliably.

The extremities of the brushes 138 may be rounded in moderation. In this configuration, the probability of causing the operation site to be damaged by the extremities of the brushes 138 when the brushes 138 are pressed against the operation site can be reliably avoided.

It is also possible to secure the portion where the brushes 138 come into abutment with the side surface of the nozzle portion 130 to the side surface of the nozzle portion 130. In this configuration, the brushes 138 are prevented from being sucked from the suction port 164. Also, in this configuration, the brushes 138 are restricted from being spread outward, and the distances between the brushes 138 can be maintained to be small over the range from the extremity of the nozzle portion 130 to the suction port 164. Consequently, the fluid accumulated in the operation site can be moved to the suction port 164 efficiently, so that the visual field in the periphery of the operation site can be maintained further suitably.

In contrast to the modification using the brushes as described above, the embodiment provided with the groove portions 134 on the side surface of the nozzle portion 130 described above only requires to form the grooves on the nozzle portion 130. Therefore, the nozzle portion 130 can be manufactured more easily. In addition, since the members such as the brushes do not have to be provided additionally, the simple configuration of the apparatus can be maintained.

Although the fluid ejection apparatus in the embodiment has been descried, the invention is not limited to all of the embodiments and the modifications described above, and various modes may be employed without departing the scope of the invention. For example, although the fluid is described to be ejected in a pulsed manner in the embodiment, the invention is not limited to a mode in which the fluid is ejected in a pulsed manner, and any mode of ejection may be employed. The fluid accumulated in the operation site can be moved by the groove portions 134 irrespective of the mode of ejection of the fluid. Therefore, with the provision of the suction port at a position apart from the operation site, the fluid in the operation site can be removed by the suction port and hence the visibility in the operation site can be secured while avoiding the operation site to be applied with the negative pressure.

This application claims priority to Japanese Patent Application No. 2009-242160, filed on Oct. 21, 2009, the entirety of which is hereby incorporated by reference.

What is claimed is:

1. A fluid ejection apparatus ejecting fluid from an ejection port, comprising:
a suction port provided at a position apart from the ejection port and applied with a negative pressure; and
a fluid channel provided between a vicinity of the ejection port and the suction port, and configured to suck the fluid in the vicinity of the ejection port by a surface tension of the fluid and move the same toward the suction port.

2. The fluid ejection apparatus according to claim 1, wherein
the ejection port is provided at an extremity of a tubular member,
the suction port is provided along an outer surface of the tubular member apart from the extremity where the ejection port is provided in an axial direction, and
the fluid channel is a channel formed of a groove provided on the outer surface of the tubular member between the position in the vicinity of the extremity and the position where the suction port is provided.

3. The fluid ejection apparatus according to claim 1, wherein
the ejection port is provided at an extremity of a tubular member,
the suction port is provided along an outer surface of the tubular member apart from the extremity where the ejection port is provided in the axial direction, and
the fluid channel is a channel formed of a plurality of fibrous members extending from the position in the vicinity of the extremity toward the suction port.

4. The fluid ejection apparatus according to claim 3,
wherein the fibrous members which constitute the fluid channel are members having extremities thereof on a side of the ejection port project outward with respect to the extremity of the tubular member.
